(19) United States
(12) Patent Application Publication
(10) Pub. No.: US 2010/0185500 A1
(43) Pub. Date: Jul. 22, 2010

(54) METHOD AND SYSTEM FOR MANAGING RISK RELATED TO EITHER OR BOTH OF LABOR LAW AND HUMAN RESOURCES

(75) Inventors: Rosanne E. Estrella, Orangevale, CA (US); James D. Estrella, Orangevale, CA (US)

Correspondence Address: SCHNECK & SCHNECK, P.O. BOX 2-E, SAN JOSE, CA, 95109-0005, US

(73) Assignee: JESTAR GROUP, LLC, Orangevale, CA (US)

(21) Appl. No.: 12/692,359

(22) Filed: Jan. 22, 2010

Related U.S. Application Data
(60) Provisional application No. 61/146,588, filed on Jan. 22, 2009.

(51) Int. Cl. G06Q 10/00; G06F 17/30; G06F 3/048; G06F 15/16

(52) U.S. Cl. 705/11; 705/320; 705/322; 707/769; 707/E17.108; 715/764; 709/219

(57) ABSTRACT

This is a system and method to assist employers in managing risks inherent in either or both of human resource and labor law relations. Human resource and labor related queries and documentation are routinely disseminated to employees through employee devices by a risk management device. A response is required from the employee device for the disseminated queries and documentation, which is captured and stored by the risk management device. Stored responses may generate alerts to designated personnel to take appropriate actions as indicated by the alerts.

### CROSS-REFERENCE TO RELATED APPLICATION

This application claims priority from U.S. Provisional Patent Application Ser. No. 61/146,588, entitled “MANAGING HUMAN RESOURCE AND LABOR RISKS,” filed Jan. 22, 2009.

### TECHNICAL FIELD

The present invention relates to a system using risk management software for employers handling risks inherent in either or both of human resource and labor relations.

### BACKGROUND

Employment related violations have been the subject of the largest number of lawsuits filed in the United States, both in state and in federal courts. There is an ever-increasing number of formal claims filed with the Equal Employment Opportunity Commission, Department of Labor, as well as state and county level governmental departments which handle such claims. There are currently more than 200 federal and state laws and hundreds of regulations that apply to almost every relationship in the workplace. According to statistics, employment issues now make up 40% of all civil litigation in the U.S. Courts. The dominant employment-related issues in litigation are discrimination, harassment, hostile work environment, retaliation, and wage and hour violations. Federal employment laws, together with parallel state laws, have expanded employees' rights in the workplace, affording new “causes of action” to be brought against employers and broader than ever rights of recovery. The number of claims and lawsuits by employees against their employers rises when the economy is down, and the number of employment-related lawsuits has risen in 2009 over the number filed in 2008. Statutes of limitations have been expanded for the employee to file suits as well.

The cost to businesses throughout the United States to settle or to pay a verdict on just one lawsuit for harassment or discrimination averages in the range from $250,000 to $2 million, not including attorneys fees.

A recent Supreme Court decision has expanded strict liability for harassment and discrimination for wrongful acts by supervisors, even if the employer was not aware of the violation.

A slightly different affirmative defense has been adopted by the California Supreme Court in State Department of Health Services v. Superior Court (McGinnis), 31 Cal. 4th 1026 (2003). Strict liability still attaches when the harasser is a supervisor. However, employers may avoid or limit damages for hostile environment, sexual harassment and discrimination by either a supervisor or non-supervisor under the “avoidable consequences” doctrine where: The employer took reasonable steps to prevent and correct wrongful employment acts (by creating policies against such wrongful acts and an accessible grievance procedure); The employee unreasonably failed to use the preventive and corrective measures provided by the employer; and Reasonable use of the employer's procedures would have prevented at least some harm to the employee. Courts have stressed that this doctrine impacts damages, not liability. However, the employee's conduct will be judged against a standard of reasonableness.

To take advantage of the defense, an employer must demonstrate that it adopted policies against discrimination, harassment and the like, that it communicated the policies to all employees, whether the employer prohibited retaliation for reporting violations that the employer's reporting and enforcement procedures protected employee confidentiality to the extent practical, and that the employer consistently and firmly enforced the policy. Relevant evidence will include anything tending to show that the employer took effective steps to encourage victims to come forward with complaints, took each complaint seriously, performed a unbiased investigation of each and every complaint, and took remedial action where necessary.

A method is needed to provide employers with risk management tools to address the above concerns and to reduce company risk and exposure to liability and/or damages. In addition, a method is needed to deter contemplated, frivolous claims and lawsuits by employees. There is also a need for generating and retaining documentation to assist in the employer's defense of a claim or lawsuit, and or to limit, if not eliminate incurred damages.

### SUMMARY

The present invention provides an effective way to address employer's needs regarding managing risks inherent in labor and employee relations. The employer's needs are achieved by the routine dissemination of queries and documentation relating to labor and human resource risks to employees through employee devices, along with the requirement that a response is generated through the employee devices to the disseminated queries and documentation. The requirement of responding to the disseminated queries allows the employer to monitor the responses and to issue alerts to designated personnel when a response indicates the necessity of action on the employer's behalf. The action may include solving employee concerns about their paycheck, investigating possible violations of employee rights, explaining company policy and procedures, etc.

Even when a response is not received, this non receipt is taken as a response which may indicate non receipt of disseminated queries and documentation by the non-responsive employee device or may indicate deliberate attempts to avoid responding. In addition, responses and information pertaining to the responses are stored and used to generate logs and reports which may be used for the dissemination of additional proactive queries and documentation.

### BRIEF DESCRIPTION OF THE DRAWINGS

FIG. 1 is a general schematic showing the major devices and networks for an embodiment of the system and method for managing risk.

FIG. 2 is a diagram showing access to various subsystems on a risk management server by an HR administrator device for an embodiment of the system and method for managing the risk.

FIG. 3 is a diagram showing dissemination of queries, documentation, and options for responding to the dissemination, to an employee device, generation of a response, storage of the response, and generation of an alert.

FIG. 4 is a diagram showing activity, by the HR administrator and an alert responder occurring after storage of the required response and generation of an alert.

### DETAILED DESCRIPTION

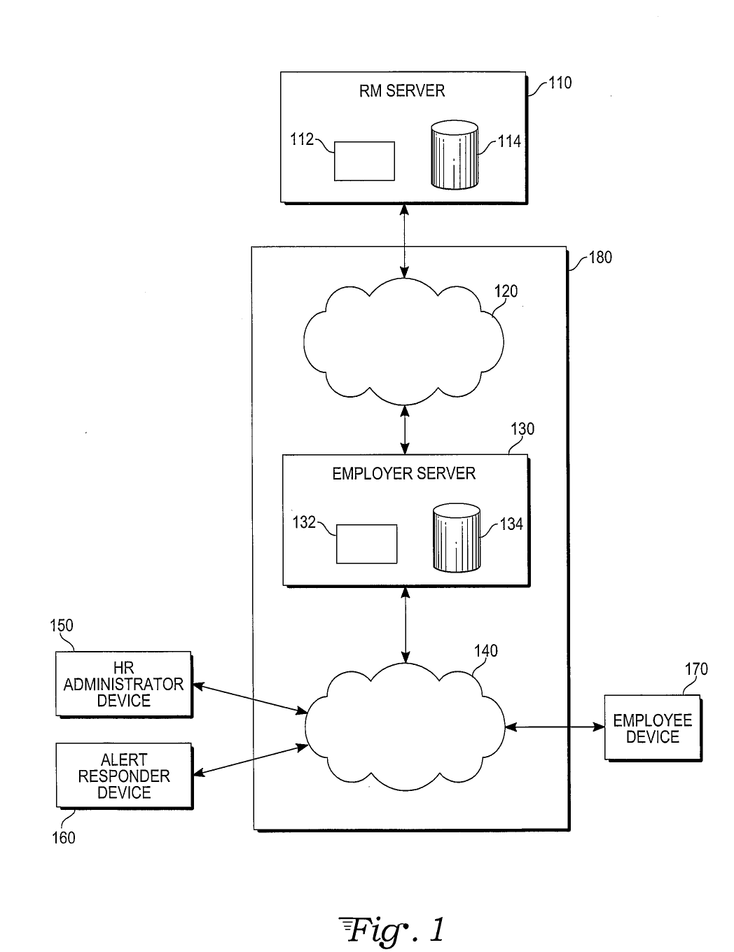

Referring to FIG. 1, there are shown an RM server 110 (where RM is an abbreviation for Risk Management, thus 110 is a risk management server which is also a device, a risk management device) of which there is at least one, the Internet 120, an employer server 130, a network 140, an HR administrator device 150, an alert responder device 160, an employee device 170, and communication path 180. The RM server 110 has software 112 and storage device 114. Specific exemplary embodiments may include a plurality of RM servers, software, and storage devices. The Internet 120 may be used for connection to and communication with employer server 130. The employer server 130 has, among other things, software 132 and storage device 134. Specific exemplary embodiments may include a plurality of employer servers, software, and storage devices. Network 140 maybe used for connection to and communication among employer server 130 and devices connected to network 140. HR administrator device 150 (where HR is an abbreviation for Human Resources), alert responder device 160, and employee device 170 are devices that are connectable to employer server through network 140 and are at least capable of communicating through network 140 with the employer server 130. Communication path 180 encompasses the various intermediating devices and networks that are accessed for connection and communication between the RM server 110 and the various devices that may be attached to network 140, such as the HR administrator device 150, the alert responder device, and the employee device 170. Referring to communication path 180, instead of continually referring to a list of its components in the following discussions, will facilitate understanding of the concepts presented in this document.

The RM server 110, a computerized device, is the primary device which implements the method for risk management. Software 112 is used by the RM server 110 to execute functions required by the RM server 110. These functions include execution of the method for risk management, and any other functions required by the RM server 110 such as communications, security, access rights to various parts of the RM server 110, accessing storage device etc. Storage device 114 is accessed and controlled by software 112 as may be required for risk management and any other storage requirements needed by the RM server 110.

The employer server 130 performs required functions by using software 132. These functions include accessing the RM server 110, and any other required functions of an employer server 130 such as communications, accessing storage device etc. Storage device 134 is accessed and controlled by software 132 as may be required for risk management and any other storage requirements needed by the employer server 130.

Network 140 may be a wide area network, a local area network, a wireless network, or any other network known in the art, even the Internet.

The HR administrator device 150, the alert responder device 160, and the employee device 170 may be any computerized device capable of connecting to and communicating with employer server 130 and also capable of connecting to and communicating with RM server 110 as illustrated by communication path 180. Also, there may be a plurality of HR administrator devices, alert responder devices, employed devices. These devices may include desktop computers, laptop computers, wireless computers, mobile telephones, logon terminals, logon kiosks, etc. The HR administrator device 150 is a device used by an HR administrator (not shown), the alert responder device 160 is a device used by an alert responder (not shown), and the employee device 170 is a device used by an employee (not shown). Note that an employee, as described in this document, is anyone with whom an employer (not shown) may be subject to labor law or human resource risks including an HR administrator and an alert responder. An employee may also be, for example, an hourly worker of the employee, a salaried worker of the employee, an owner of a company, a contractor working for the employer, etc.

In other embodiments, the RM server 110 may be a server or a plurality of servers directly connected to network 140 and thus part of network 140. In yet other embodiments, there may not be an RM server 110 and the software 112 and storage device 114 may be internal to the employer server 130 or to a plurality of employer servers.

An employer specific risk management system (RM system) is created at the RM server 110 (which is an abbreviation for risk management server). An RM system is limited to a specific employer and the employees of the specific employer. Different RM systems for different employers are kept separate and an RM system of one employer is not accessible by another employer and the other employer's employees. In addition, parts of an employer's RM system may only be accessed by HR administrators, alert responders, employees, etc who have appropriate security clearance. In addition, a password protected interface may be used by the RM server 110 which uses the security and access rights of employers, HR administrators, alert responders, employees etc and restricts access to not only the correct RM system but also to the various parts of the RM system. Security, access rights, and interfaces which to accomplish the above are well known in the art and need not be discussed further.

The RM system is initialized, allowing access by the employer server 130, HR administrator device 150, alert responder device 160, employee device 170, etc. and proceeds in the following manner. This initialization may be done by initialization specialists who are responsible to and for the RM server 110. Typically, they are not employees of the employer and have no direct relationship with the employee. Initialization may also be done by designated personnel. The designated personnel are employees designated by the employer to perform specific designated tasks related to risk management. The tasks may include initializing as discussed above, responding to alerts, conducting investigations, writing performance reviews of employees etc. The designated personnel may include HR administrators, alert responders, security personnel, accounting personnel, computer programmers, etc. Specific areas of the RM server 110, software 112, and storage device 114 are designated, with appropriate URLs and access control rights, for secured access by the employer server 130, HR administrators, alert responders, and employees. The setup is such that employer server 130 and the employer's employees have access to only the specific areas of the RM system on RM server 110, software 112 and storage device 114. An employer and the employer's employees are restricted from accessing other RM systems on the RM server 110, software 112 and storage device 114 which are set up for different employers. Thus, a single RM server 110 may provide separate, secure, and independent RM systems for a plurality of employers.

Additional initialization primarily entails use of software 132 to enter information or data, and parameters into parts of storage device 134 which are dedicated to the RM system. The data and parameters include the names of employees who will access the RM system along with appropriate employee identification information. The employee identification information may include employee ID numbers, employee email addresses, employee access control rights to specific areas of the RM server 110 or software 112 or storage device 114, etc. which comprise the RM system. Further, the employee's logon script to the employer server 130 may be modified to allow redirection to the RM server 110 when the employee logs on to the employer server 130. An applet is also installed at the employee device 170 and is accessible at all times. The applet may be used to access RM server 110 and, when modification of the logon script is not possible or not allowed, the applet allows communication between the RM server 110 and the employee device 170 through communication path 180, thereby enabling dissemination to the employee device 170 and, in some embodiments, to the plurality of employee devices. In addition, risk related information or data for dissemination to employees may be entered into the RM server 110 in storage device 114 and scheduled for delivery to employees in software 112. In other embodiments, the risk related information may include required responses to the risk related information or data which is disseminated. After initialization is completed, maintenance and update to the initialization information or data and parameters may be performed by the designated personnel of the employer. Note, that the terms data and information will be used interchangeably.

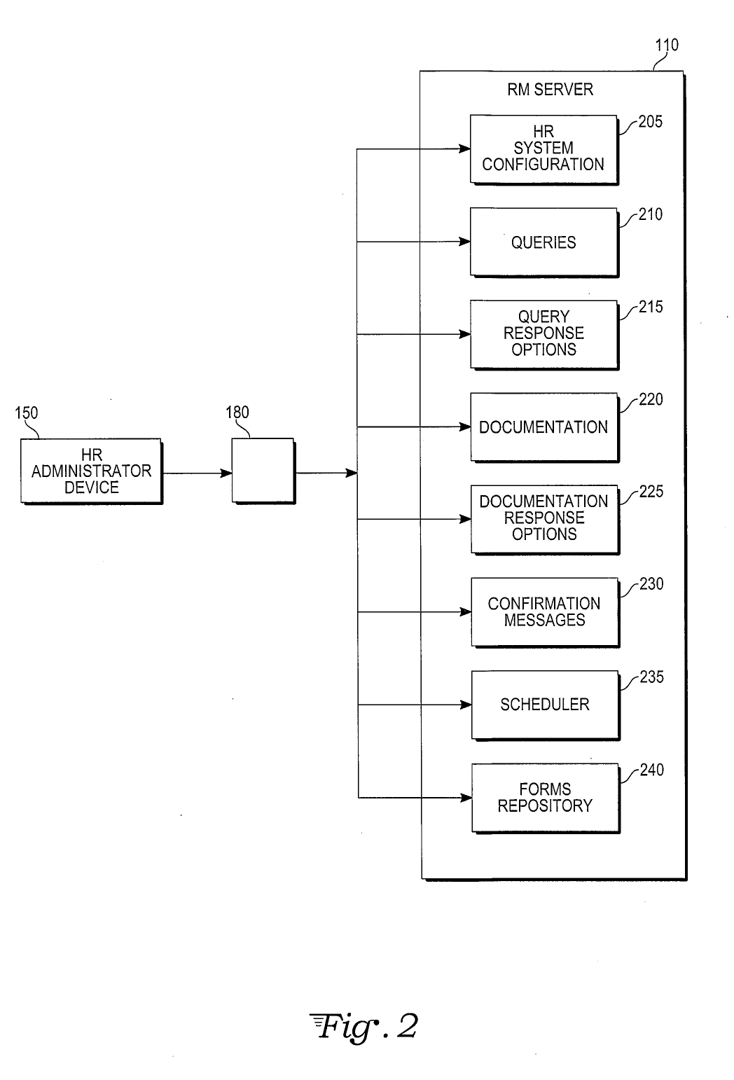

Referring to FIG. 2, designated personnel such as, but not limited to, an HR administrator (not shown) may perform update and maintenance of various information or data and parameters of the RM system, indicated in blocks 205-240, which are stored in storage device 134 of FIG. 1 through use of the HR administrator device 150 and software 132. The HR administrator uses the HR administrator device 150 to access the RM system on the RM server 110 thru the communication path 180. The HR administrator device 150 may access any of the blocks 205-240 for which the HR administrator has the proper security clearance.

In block 205, the HR administrator may perform various administration tasks. A particular administration task may involve employees, where new employees may be added or an employee's status may be changed to such things as, on leave, on vacation, terminated, etc. Another administration task may be changing security and access rights for employees. Another administration task may be designating alerts for specific response/query combinations and specific response/documentation combinations and which designated personnel will be selected as alert responders for the designated alerts so they may take appropriate action required by the alert.

The HR administrator may access queries in block 210 to add, or update an individual query. Once disseminated, a query is not deleted even when modified to be a more recent version of the query. The queries in block 210 are questions that may be disseminated to employees basically asking employees whether they perceive or know about human resource or labor law concerns or problems. One query may ask whether an employee has awareness of an occurrence which the employee considers to be in violation of employment rights. Another query may ask whether compensation of the employee is consistent with expectations of the employee. Another query may ask whether the employee has experienced or witnessed an incident or occurrence which he or she perceives to be a violation of their or their co-worker's employment rights which he or she has not reported prior to the date of the question. Another query may ask whether the employee's paycheck correctly reflected pay for all hours worked in that pay period. Another query may ask whether the employee has been injured. Another query may ask whether the employee has a claim against the employer.

The HR administrator may access query response options in block 215 to add or update an individual query response option. Each query response option contains a list of selectable responses that pertain to an individual query and is disseminated to employees with the individual query. The selectable responses for most queries, such as whether an employee perceives or knows about human resource or labor law concerns or problems, are “yes” or “no.” The selectable responses for queries such as whether compensation of the employee is consistent with expectations of the employee are “I confirm my paycheck was accurate,” “No, my paycheck was not accurate,” and “Need clarification on my pay, deductions or benefits.”

The HR administrator may access documentation in block 220 to add or update an individual document which may be disseminated to employees. The individual document may be employer policy, employer procedures, federal and state-required posting law and their updates, employee/employer obligations and company announcements, or any document related to labor law and human resource risks. As with queries 210, documents, once disseminated are not deleted. Disseminated documents are also stored with additional information such as version, date and time of dissemination etc. When a disseminated document is modified, the previous version of the document is retained. This method of retaining provides historical documentation regarding what policies, procedures, laws or regulations were in place for any relevant time period.

The HR administrator may access document response options in block 225 to add or update an individual set of document response options. The individual sets contain a list of specific selectable responses that pertain to a disseminated document and are disseminated to employees with the disseminated document. A specific selectable response in an individual set of specific selectable responses to a disseminated document is “Read Later.” Options of “Read and Understood” or “Need Clarification” are selectable responses when an employee accesses the disseminated document and presumably reads the disseminated document.

The HR administrator may access specific confirmation messages which pertain to specific selectable responses, which generate alerts, in block 230 to add or update the specific confirmation messages or confirmation response options. A specific confirmation message is disseminated to employees when an employee's designation of a specific selectable response generates an alert, signifying a labor law or human resource risk, which will be discussed at a later point. The specific confirmation messages may contain wording to indicate that in an effort to provide a professional and harmonious work environmental, all reports are taken seriously and that the company is prepared to conduct an unbiased investigation and take corrective action if necessary. Confirmation response options contain selectable responses which include “Send My Response” or “Go Back to Previous Screen.”

The HR administrator may access a scheduler 235. The scheduler allows adjustment of parameters for creating and controlling dissemination routines for enabling routine dissemination to employees risk related information such as of queries 210, query response options 215, documentation 220, and documentation response options 225. The routine dissemination may be scheduled to occur during fixed time intervals, as the result of a specific event such as when an employee logs on or off to employer server 130 of FIG. 1 or employee's pay date, as dictated by employer policies and procedures, to all employees, specific employees, groups of employees, employees generating any alerts, employees generating a specific alert, etc. Additionally, non-routine dissemination may be implemented, such as transmissions that occur at the discretion of designated personnel.

The HR administrator may access a forms repository 240 to add or update forms that may be used for risk management such as an investigation report form and an employee review form.

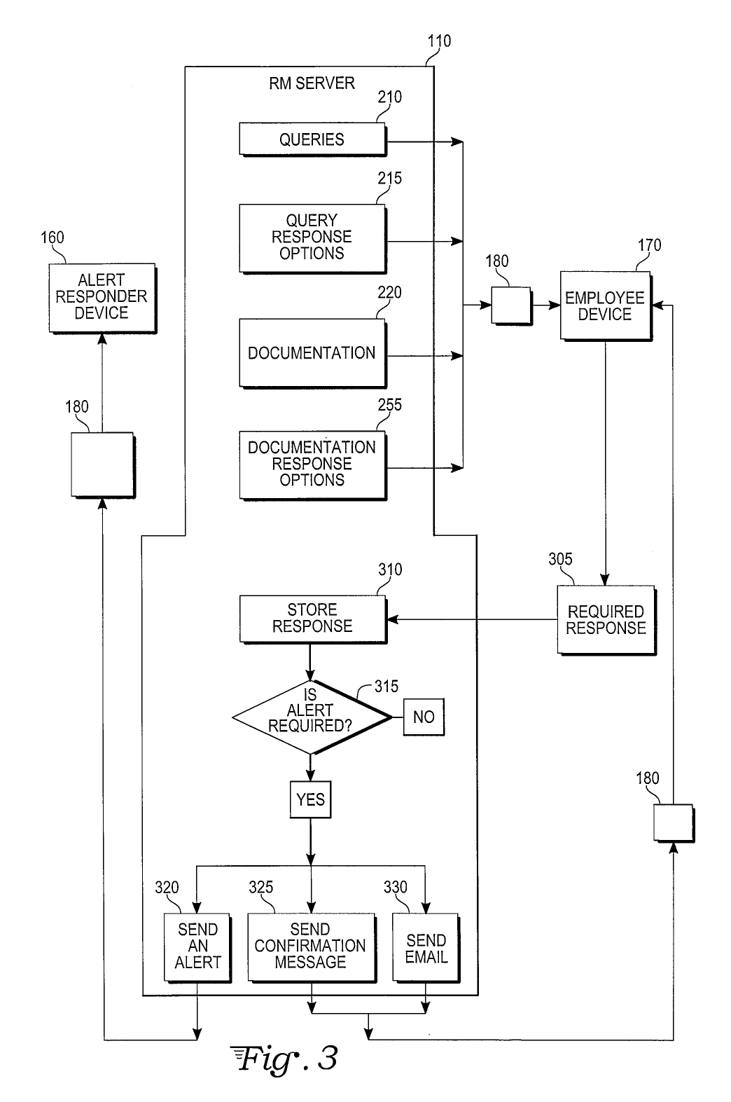

Referring to FIG. 3, at least one query stored in queries 210, along with a corresponding query response option stored in query response options 215, is disseminated through communication path 180 to employee device 170 for an employee using employee device 170. The dissemination may be displayed at the employee device in a popup window or other suitable manner. The employee device is prevented from leaving the popup window and further operation until the response is captured and received by the RM server 110. Dissemination may be done routinely per the dissemination routines of the scheduler 235 of FIG. 2 or on a non-routine basis by designated personnel.

An illustrative example of a query is a query pertaining to whether an employee has awareness of an occurrence which the employee considers to be in violation of employment rights. The corresponding query response option has two selectable responses “Yes” or “No” and one of which must be specifically selected, with a user input device such as a computer mouse at the employee device 170, thus becoming a required response 305. The required response 305 is captured by the RM server 110 and stored with previously stored required responses by block 310 in storage device 114 of FIG. 1. Block 315 accesses the designated alerts from block 205 of FIG. 2 and determines whether an alert is required. A stored response of “No” indicating that there is no violation of employee rights and hence no risk to the employer, would not require an alert in block 315. A stored response of “Yes,” indicating that there are perceived concerns regarding violation of employee rights and hence a risk may exist to the employer, would require an alert in block 315.

In block 320, an alert is sent by an appropriate means, such as email, via communication path 180 to the appropriate alert responder device 160 of the designated personnel indicated by block 205 of FIG. 2. The designated personnel in this instance may be a HR administrator. Also an appropriate specific confirmation message from block 230 of FIG. 2 is sent in block 325 along with an email in block 330 via communication path 180 to the employee device 170. Both the specific confirmation message and the email sent to the employee device 170 confirm that the response has been forwarded to the appropriate designated personnel, and that the designated personnel will be contacting the employee to discuss the details within the time set forth in the employer's reporting policies and procedures.

A documentation 220 example will now be discussed An illustrative example of at least one document stored in documentation 220 along with a corresponding document response option stored in document response options 255 is disseminated through communication path 180 to employee device 170 for an employee using employee device 170. The dissemination as discussed above may be displayed at the employee device in a popup window or other suitable manner. The employee device is prevented from leaving the popup window and further operation until the response is captured and received by the RM server 110. Dissemination may be done routinely per the dissemination routines of the scheduler 235 of FIG. 2 or on a non-routine basis by designated personnel.

An illustrative example of a document is a document pertaining to employment law. If more than one document is disseminated, the documents may appear at the employee device 170 in a list. A document may be selected for reading at the employee device 170 or a response of “Read Later” may be specifically selected, with a user input device such as a computer mouse at the employee device 170, thus becoming the required response 305. The required response 305 is captured by the RM server 110 and stored with previously stored required responses by block 310 in storage device 114 of FIG. 1. Block 315 accesses the designated alerts from block 205 of FIG. 2 and determines whether an alert is required. The response of “Read Later” would not require an alert.

When a document is selected for reading, the corresponding selectable responses from the document response options 255 are “Read and Understood” or “Need Clarification.” When “Read and Understood” is specifically selected, with a user input device such as a computer mouse at the employee device 170, it becomes the required response 305 and capturing by RM server 110 and storing by block 310 proceeds as described above. Block 315 processes the response as described above with block 205 as described to determine if an alert is required. Since the employee understands the document, an alert is not required. When “Need Clarification” is specifically selected, with a user input device such as a computer mouse at the employee device 170, as the required response 305, it is captured by RM server 110, stored with previously stored required responses by block 310, and then processed by block 315 to determine if an alert is required. In this case, since the document is not understood and block 315 determines that an alert is required, blocks 320, 325, and 330 function as described above for queries. Unread documents may be accessed at any time by interfacing with RM server 110 with the applet.

The required responses which are stored in block 310 are stored with additional information such as an incident ID, the relevant query if a query was disseminated, the relevant documentation or an indication of the documentation if documentation was disseminated, identification of the employee who responded, whether an alert was generated and if so identification of the designated personnel to whom the alert was sent, and pertinent dates including dates related to dissemination, the response, and the alert.

A response is required regardless of the type of dissemination. Non receipt of responses by RM server 110 are captured as default responses. For example, if a required response is not received by RM server 110, then non receipt is captured and stored by block 310 as a default response and an alert would be required in block 315. Prolonged time lapses after dissemination may be used to determine non receipt. Non receipt of the required response 305 may occur for numerous reasons such as non receipt of dissemination by the employee device 170 or improper functioning of the employee device 170 etc. In other embodiments, an employee may be able to use an escape key and thereby force the employee device 170 to terminate the popup window thereby not generating the required response 305. In these embodiments, a response indicating a refusal to respond is stored in block 310 and an alert would be required in block 315.

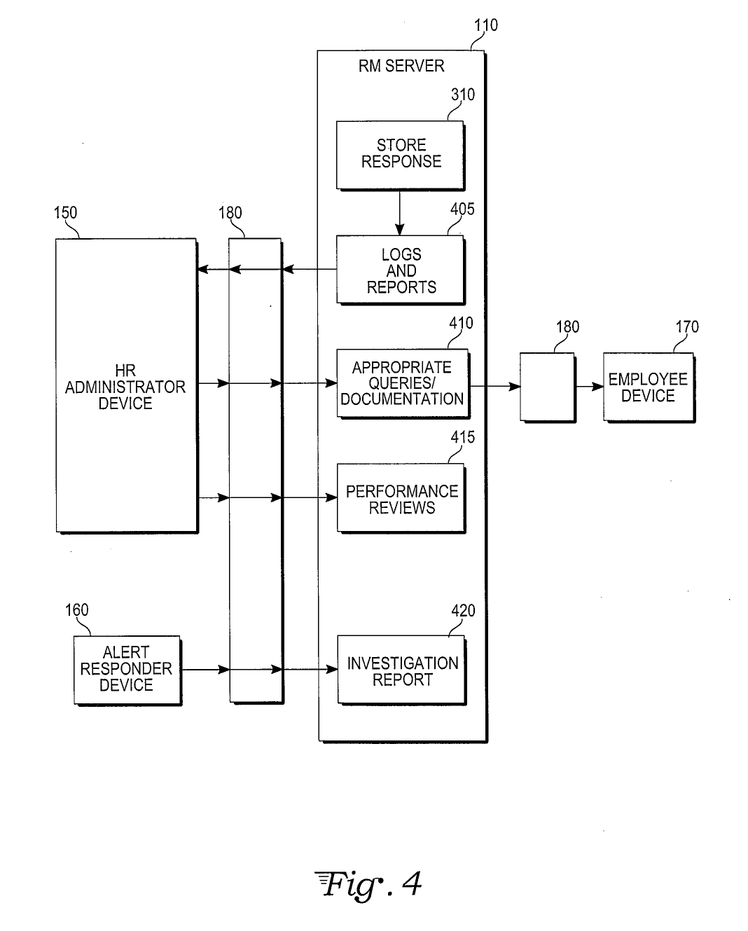

With reference to FIG. 4, required responses which are stored in block 310 are used by RM server 110 to create various logs and reports 405 which are stored on storage device 114 of FIG. 1 and which may be accessed by designated personnel such an HR administrator at the HR administrator device 150 via the communication path 180. The logs and reports 405 may illustrate such things as received alerts, employees who have generated alerts, employees who have not yet read disseminated documents, employees who need clarification regarding documents, what versions of documentation were disseminated over specific time intervals, etc. Accessing the logs and reports 405 enables an HR administrator to disseminate appropriate queries/documentation 410 to an employee device 170, and in some embodiments to a plurality of employee devices, based on the logs and reports 405. Possible appropriate queries/documentation may be the dissemination of portions of the policy and procedure documents pertaining to reading the disseminated documents to an employee device 170 of an employee who has always chosen to read documents later and never selected any documents to read.

In addition, an HR administrator may use HR administrator device 150 to access the forms repository 240 of FIG. 2, select an employee review form, and store the completed employee review form as a performance review for an employee in performance reviews 415.

An alert responder may use the alert responder device 160 to access the forms repository 240 of FIG. 2, select an investigation report form, complete the form, and store form as investigation report in block 420. This process of completing and storing the appropriate form may be a required response to a particular alert that is generated upon receiving a response from an employee, thereby building up a collection of investigation reports.

What is claimed is:

1. A computerized method of managing risk related to labor law or human resources comprising:
routinely disseminating, with respect to the risk, a query or documentation by a computerized risk management server over a network to a computerized device of an employee;
requiring, by the risk management server, a response from the computerized device of the employee pertaining to receipt of the query or the documentation;
capturing the response, by the risk management server; and
storing the response, by the risk management server, for access by designated personnel.

2. The method of claim 1 further comprising routinely disseminating, by the risk management server, query response options with and having pertinence to the query, and documentation response options with and having pertinence to the documentation to the computerized device of the employee.

3. The method of claim 2 wherein disseminating the query response options and the documentation response options includes presenting selectable responses to the query and the documentation respectively and includes enabling selection of a specific selectable response using a user input device of the computerized device of the employee.

4. The method of claim 1 further comprising capturing and storing as a default response, a failure to receive the response from the computerized device of the employee.

5. The method of claim 1 further comprising disseminating, with respect to the risk, the query or the documentation by the risk management server over the network to the computerized device of the employee on a non-routine basis.

6. The method of claim 1 further comprising establishing dissemination routines for routinely disseminating, the dissemination routines including at least one of:
disseminating on a basis of fixed time intervals;
disseminating as a result of a specific event, the specific event including at least one of logon, logoff, and pay date;
disseminating as dictated by pre-established policy and procedures; and
disseminating at discretion of the designated personnel;

7. The method of claim 1 further comprising generating an alert pertaining to the response, for which appropriate action by the designated personnel is indicated, and storing and forwarding the alert to the designated personnel by the risk management server.

8. The method of claim 7 further comprising storing, by the risk management server, an investigation report resulting from the alert.

9. The method of claim 1 further comprising creating and maintaining queries, the documentation, query response options, and documentation response options by the designated personnel which are stored by the risk management server.

10. The method of claim 1 further comprising creating and maintaining specific confirmation messages for specific selectable responses by the designated personnel which are stored by the risk management server and further comprising forwarding the specific conformation messages to the computerized device of the employee when the specific selectable responses are captured by the risk management server.

11. The method of claim 1 further comprising preventing the computerized device of the employee from further operation until the response is captured by the risk management server.

12. The method of claim 1 further comprising accessing a scheduler, able to be scheduled for dissemination with respect to the risk, which is accessible by the designated personnel, at the risk management server, for scheduling dissemination with respect to the risk.

13. The method of claim 1 further comprising accessing forms, able to be accessed by the designated personnel at the risk management server, the forms including a performance review form and an investigation report form.

14. The method of claim 1 wherein storing the response comprises storing information indicative of:
an incident ID;
the query;
the documentation;
the response;
identification of the employee who responded;
an alert, pertaining to the response for which appropriate action by the designated personnel is indicated;
pertinent dates including dates related to dissemination, the response, and the alert; and
identification of the designated personnel to whom the alert is sent.

15. The method of claim 1 further comprising establishing logs and reports, based on stored responses and other information stored by the risk management server, the logs and reports being accessible by the designated personnel.

16. The method of claim 15 further comprising disseminating the query, query response options, the documentation, and documentation response options based on the logs and reports.

17. The method of claim 1 further comprising creating and maintaining performance reviews using a performance review form configured for completion by the designated personnel and further comprising storing the performance reviews within the risk management server.

18. In a computer system, a method of managing risk related to labor law or human resources comprising:
establishing a routine for recurringly acquiring risk related information over a network by at least one risk management device, the risk related information being indicative of perceived concerns of employees with respect to the risk, the risk related information including required responses to at least one query which is routinely disseminated over the network by the at least one risk management device to employee devices, the at least one query being specific to,
whether an employee has awareness of an occurrence which the employee considers to be in violation of employment rights, or
whether compensation of the employee is consistent with expectations of the employee; and
capturing, recording and storing, by the at least one risk management device, the required responses to the at least one query for access by designated personnel.

19. The method of claim 18 further comprising routinely disseminating to the employee devices, by the at least one risk management device, query response options with and having pertinence to the at least one query.

20. The method of claim 19 wherein disseminating the query response options includes presenting selectable responses to the at least one query and includes enabling selection of a specific selectable response using a user input device of the employee devices.

21. The method of claim 18 further comprising capturing and storing as default responses a failure to receive the responses from the employee devices.

22. The method of claim 18 further comprising disseminating, with respect to the risk, the at least one query by the at least one risk management device over the network to the employee devices on a non-routine basis.

23. The method of claim 18 further comprising establishing dissemination routines for routinely disseminating, the dissemination routines including at least one of:
disseminating on a basis of fixed time intervals;
disseminating as a result of a specific event, the specific event including at least one of logon, logoff, and pay date;
disseminating as dictated by pre-established policy and procedures; and
disseminating at discretion of the designated personnel;

24. The method of claim 18 further comprising generating alerts pertaining to the responses, for which appropriate action by the designated personnel is indicated, and storing and forwarding the alerts to the designated personnel by the at least one risk management device.

25. The method of claim 24 further comprising storing, by the at least one risk management device, investigation reports resulting from the alerts.

26. The method of claim 18 further comprising creating and maintaining the at least one query and query response options by the designated personnel which are stored by the at least one risk management device.

27. The method of claim 18 further comprising creating and maintaining specific confirmation messages for specific selectable responses by the designated personnel which are stored by the at least one risk management device and further comprising forwarding the specific conformation messages to the employee devices when the specific selectable responses are captured by the at least one risk management device.

28. The method of claim 18 further comprising preventing the employee devices from further operation until the responses are captured by the at least one risk management device.

29. The method of claim 18 further comprising accessing a scheduler, able to be scheduled for dissemination with respect to the risk, which is accessible by the designated personnel, at the at least one risk management device, for scheduling dissemination with respect to the risk.

30. The method of claim 18 further comprising accessing forms, able to be accessed by the designated personnel at the at least one risk management device, the forms including a performance review form and an investigation report form.

31. The method of claim 18 wherein storing the responses comprises storing indicative of:
an incident ID;
the at least one query;
the responses;
identification of the employees who responded;
alerts, pertaining to the responses for which appropriate action by the designated personnel is indicated;
pertinent dates including dates related to dissemination, the responses, and the alerts; and
identification of the designated personnel to whom the alerts are sent.

32. The method of claim 18 further comprising establishing logs and reports, based on stored responses and other information stored by the at least one risk management device, the logs and reports being accessible by the designated personnel.

33. The method of claim 32 further comprising disseminating the at least one query and query response options based on the logs and reports.

34. The method of claim 18 further comprising creating and maintaining performance reviews using a performance review form configured for completion, by the designated personnel and further comprising storing the performance reviews within the at least one risk management device.
